(19) United States
(12) Patent Application Publication
(10) Pub. No.: US 2002/0188533 A1
(43) Pub. Date: Dec. 12, 2002

(54) Methods and systems for managing financial accounts having adjustable account parameters

(75) Inventors: Wayne T. Sanchez, Sandy Hook, VA (US); Jeremy Clifford, Arlington, VA (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/147,069

(22) Filed: May 17, 2002

Related U.S. Application Data
(60) Provisional application No. 60/293,214, filed on May 25, 2001.

(51) Int. Cl. G06F 17/60

(52) U.S. Cl. 705/30

(57) ABSTRACT

Methods, systems, and articles of manufacture consistent with certain principles related to the present invention allow a financial account provider to provide a financial account with parameters that may be adjusted based on payment activities of the account. The financial account provider may monitor the payment activity for the account, such as consecutive payments, on time payments, missed payments, late payments, etc., and adjust the account parameters accordingly. In one configuration consistent with the present invention, the financial account provider may increase an interest rate for the account when a payment is received late. Alternatively, the customer may increase an account limit and/or decrease the interest rate for the account when the provider received a certain number of consecutive on-time payments.

### CROSS REFERENCE TO RELATED APPLICATION

This application claims the benefit of U.S. Provisional Patent Application No. 60/293,214, filed May 25, 2001, the disclosure of which is expressly incorporated herein by reference in its entirety.

### BACKGROUND OF THE INVENTION

1. Field of the Invention

Methods and systems consistent with the present invention relate to managing financial accounts, and more particularly, to financial accounts having adjustable account parameters.

2. Background and Material Information

Credit card products have become so universally well known and ubiquitous that they have fundamentally changed the manner in which financial transactions and dealings are viewed and conducted in society today. Credit card products are most commonly represented by plastic card-like members that are offered and provided to customers through financial account providers (such as banks and other financial institutions). With a credit card, an authorized customer or cardholder is capable of purchasing services and/or merchandise without an immediate, direct exchange of cash. With each purchase, the cardholder incurs debt to their financial account, which the cardholder may thereafter pay upon receipt of a periodic, for example, monthly, statement. In most cases, the cardholder will have the option to either fully pay the outstanding balance or, as a matter of necessity or choice, defer at least a portion or the balance for later payment with accompanying interest or finance charges for the period during which payment of the outstanding debt is deferred (also referred to as a revolving charge credit line).

The spending power of a credit card (i.e., the maximum amount of funds that is financed to the cardholder for making purchases) is typically limited to a particular amount that is predetermined by the issuer of the card. This amount is commonly referred to as the “credit limit” of the credit card. The credit limit provides the cardholder with a line of credit (also referred to as a credit line). The size of the issuer-imposed credit limit is generally based on a number of non-exclusive factors, the most important of which are often the cardholder's earning capacity and the cardholder's credit history. When purchases are made or debts incurred with the credit card, the available portion of the credit limit is reduced by the purchase or debt amounts. In addition, interest and/or finance charges are also subtracted from the available portion of the credit limit on a periodic basis. The total debits on a credit card are referred to as the “outstanding balance,” while the remaining or available balance of the credit limit is typically called the “available balance” and reflects the dynamically adjusted current spending power of the credit card. The cardholder may increase the available balance up to the credit limit, by paying the outstanding balance to the issuer.

Although the financial benefits of possessing credit card accounts are obvious, the disadvantages of abusing such accounts are sometimes overlooked by cardholders. Mismanagement of credit card accounts (not to mention other types of financial accounts such as mortgages, vehicle loans, etc.) can result in a credit profile that creditors, including financial account providers, view as high risk. A high risk credit profile may prevent an individual from receiving other financial accounts from a financial account provider. This not only affects the individual in a negative manner (e.g., the loss of potential spending power), but the financial account provider as well (e.g., the loss of a potential customer). Further, customers who consistently make timely payments to a financial account provider are often not rewarded for their diligence in making these payments. Accordingly, there is a need for an improved method and system enabling a provider of a financial account to adjust the account's parameters based on the customer's payment activities.

### SUMMARY OF THE INVENTION

Methods and systems consistent with the present invention provide an incentive structure that encourages a customer of a financial account to make proper payments.

In one aspect of the present invention, the system may perform a process for managing a financial account having an account parameter for a customer. The process may include providing, to the customer, payment criteria that indicates that the account may be adjusted if the payment criteria is met. Further, the system may determine whether the payment criteria is met based on payments made to the account and adjusts the account parameter based on the on the determination.

Both the foregoing general description and the following detailed description are exemplary and are intended to provide further explanation of the embodiments of the invention as claimed.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 illustrates an exemplary system environment in which certain features and principles related to the present invention may be implemented;

FIG. 2 is a flowchart of an exemplary process for offering target customers a financial account, consistent with certain principles related to the present invention;

FIG. 3 is a flowchart of an exemplary process for processing responses from a target customer, consistent with certain principles related to the present invention; and

FIG. 4 is a flowchart of an exemplary tracking process, consistent with certain principles related to the present invention.

### DETAILED DESCRIPTION

The present invention is directed to methods, systems, and articles of manufacture for providing a customer with a financial account having parameters that may be adjusted based on the customer's payment activities. Systems consistent with the present invention create an incentive structure that encourages proper payments to the account by notifying the customer that an account parameter will be adjusted if predetermined payment criteria is not met. For instance, the customer may be notified that an account parameter may be adjusted to a more favorable value if the customer meets the payment criteria, such as by making a consecutive number of timely payments. The customer may also be notified that the account parameter will be adjusted to a less favorable value if the payment criteria is not met. In either case, the inventive structure may be presented to the customer before or after the account is opened. In one implementation, the customer is notified each payment cycle with updated payment criteria that, if met, will cause adjustment of an account term.

Account parameters adjusted to be “more favorable” to the customer may be any account parameter (e.g., credit limit, interest rate, annual or monthly fee, etc.) adjusted to a value that is more beneficial to the customer. For instance, adjusting an account's interest rate or annual fee to a lower value is more favorable to the customer since the customer will then pay less. Similarly, adjusting an account's credit limit to a higher value is more favorable to the customer since the customer has more spending power

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and aspects of these processes may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instructions or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

Reference will now be made in detail to the invention, examples of which are illustrated in the accompanying drawings. Wherever possible, the same reference numbers will be used throughout the drawings to refer to the same or like parts.

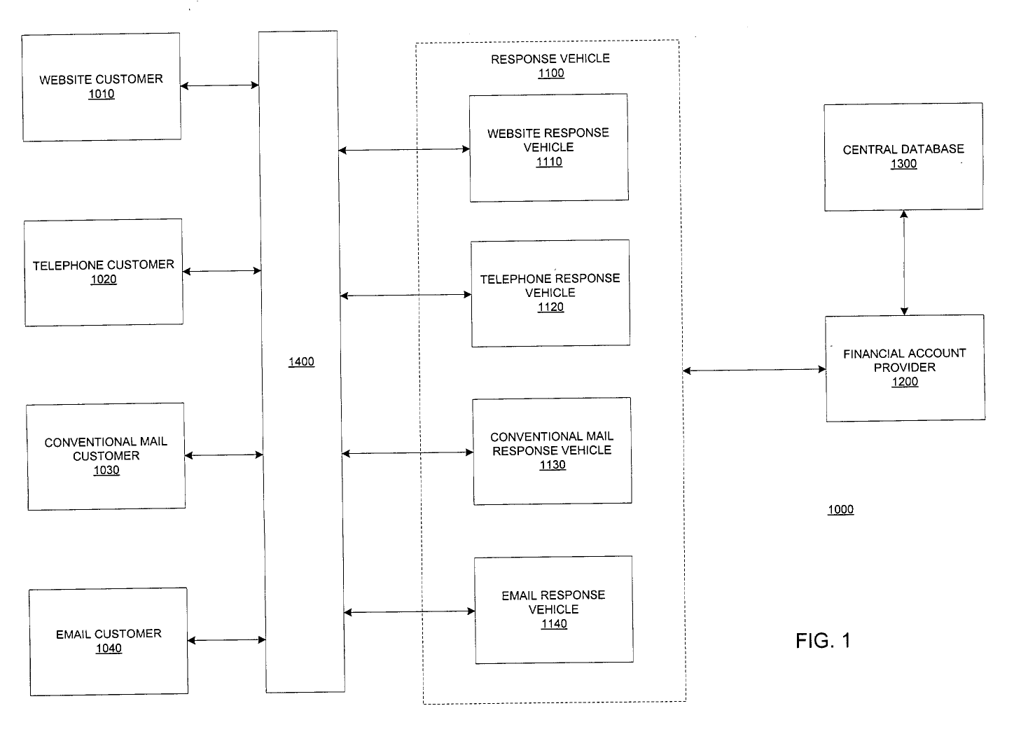

FIG. 1 illustrates an exemplary system environment 1000 in which the features and principles of the invention may be implemented. As illustrated in FIG. 1, the system environment 1000 includes a plurality of customers (1010-1040), a response vehicle system 1100 including a plurality of different response vehicles (1110-1140), a financial account provider 1200, a central database 1300, and a communications channel 1400.

Each customer in system environment 1000 is associated with a different customer category. For instance, customer 1010 may be a web site customer that accesses and retrieves information through a web site on the World Wide Web of the Internet. Customer 1020 may be a telephone customer that accesses and receives information using conventional telephonic communication techniques and systems. This includes, for example, wireline and wireless telephony systems. Customer 1030 may be a conventional mail customer that accesses and receives information by conventional mail techniques and services. This includes, for example, a customer that is part of a financial account provider's mailing list. Finally, customer 1040 may be a customer that accesses and receives information using electronic mail services. Customers 1010-1040 may also represent entities (such as an individual, a group of individuals, corporate entities, or any combination thereof) that hold financial accounts with the financial account provider 1200. The categories of customers illustrated in FIG. 1 are exemplary and should not be considered limiting. For example, a variety of different customer categories may also be implemented in environment 1000, such as customers using kiosk computers or personal digital assistants (PDAs).

Response vehicle 1100 represents a system for handling communications between the customers 1010-1040 and financial account provider 1200. Response vehicle 1100 may be part of a financial account provider's network and, as shown in FIG. 1, include a plurality of response vehicles 1110-1140 that correspond to different categories of customers 1010-1040. Each response vehicle is responsible for handling communications to and from customers based on the customers' category. For example, website response vehicle 1110 may handle Internet related communications, such as web based transactions, between customer 1010 and financial account provider 1200. Telephone response vehicle 1120 handles telephonic communications between the customer 1020 and financial account provider 1200. Thus, in the event financial account provider 1200 wishes to solicit customers telephonically, response vehicle 1120 includes the necessary systems to support such operations including, for example, operators and telecommunications equipment to communicate with customers 1020. Response vehicle 1130, on the other hand, includes the necessary systems and organizations to handle conventional mail processing to and from customers 1030. Response vehicle system 1140 includes the necessary systems and organizations to process electronic mail transactions with customers 1040. Response vehicle system 1100 may receive responses from the customers and forward them to financial account provider 1200 for appropriate processing. Notifications to the customers also are performed from issuer 1200 to the customer through response vehicle 1100. The notifications may include, for example, messages indicating an acceptance by financial account provider 1200 for the customer to receive a financial account consistent with certain principles related to the present invention. Furthermore, response vehicle 1100 may provide financial accounts to accepted customers through an appropriate response vehicle, such as conventional mail response vehicle 1130.

Communication channel 1400 facilitates communications between the various customers and response vehicle system 1100 illustrated in FIG. 1. Such communications may include communications related to offering and issuing lines of credit to selected customers. Communications channel 1400 may include, for example, a conventional mail distribution network such as that provided by the U.S. Postal Service, a telephony-based network, a local area network (LAN), a wide area network (WAN), a dedicated intranet, the Internet, and/or a wireless network. Further, any suitable combination of wired and/or wireless components and systems may be incorporated into communications channel 1400. Any suitable combination of point-to-point communications or networked communications may also be incorporated into communication channel 1400 to facilitate communication between the different entities illustrated in FIG. 1. Moreover, any part of communication channel 1400 may implemented through traditional infrastructures or channels of trade, to permit operations associated with credit card offers to be performed manually or in-person by the various entities illustrated in FIG. 1.

Financial account provider 1200 receives communication information from response vehicle system 1100 and processes it using central database 1300. Database 1300 may contain various information including credit information, potential customer lists, risk scores for potential and current customers, approved customers, credit limits for approved customers, customer information, purchase information, authorization information, and/or settlement information. Provider 1200 also sends information to response vehicle system 1100 for delivery to the appropriate customers. Financial account provider 1200 may be responsible for providing and establishing various types of financial accounts, such as credit card accounts. Financial account provider 1200 may include one or more of the following: a bank, an acquiring bank, a merchant bank, a merchant or any commercial institution capable of providing a financial account, such as a credit card account, consistent with the features disclosed herein. Also, financial account provider 1200 may include a system of processing elements and software that is used to perform functions consistent with certain features related to the present invention. Further, although FIG. 1 only illustrates one financial account provider 1200, it is of course possible that more than one financial account provider be provided in system environment 1000.

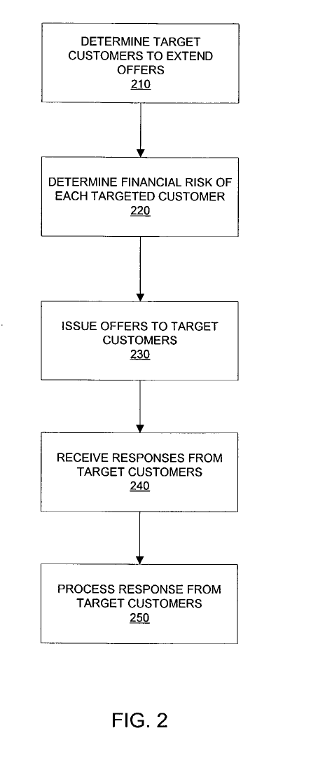

FIG. 2 illustrates an exemplary process associated with providing offers to target customers for a financial account consistent with certain principles related to the present invention. According to one aspect of the invention, system 1000 may allow financial account provider 1200 to identify specific target customers to receive an offer for a Start Good Stay Good (SGSG) financial account consistent with certain principles related to the present invention (Step 210). To identify a target customer, system 1000 may allow financial account provider 1200 to access central database 1300 to obtain financial account information associated with potential customers. The financial account information may include, for example, financial account data for customers of financial account provider 1200, such as account numbers and account parameters for each credit line associated with a customer (i.e., interest rates, credit limits, terms and conditions). The financial account information may also include payment history information and personal financial information, such as annual income, debts and assets, etc. for customers of financial account provider 1200. The customer account database may also include financial information of potential customers of financial account provider 1200. A potential customer may be an individual who may not have a financial account with financial account provider 1200, but may be targeted as an individual whom financial account provider 1200 may want to offer a SGSG credit card product.

System 1000 may utilize the information included in central database 1300 to identify the target customers to extend offers for a SGSG financial account. For example, system 1000 may allow financial account provider 1200 to target customers with a propensity to mismanage funds (e.g., carry a high balance, have declared bankruptcy, etc.). Alternatively, financial account provider 1200 may target customers who have a history of making timely payments, have a high income, etc.). The target customers may be grouped and placed in a file within central database 1300 or each customer may be flagged as a potential customer in pre-existing files maintained in database 1300. One skilled in the art would realize that system 1000 may allow financial account provider 1200 to determine a target customer based on a number of different financial information and the present invention is not limited to the examples described above.

Once the targeted customers are determined, financial account provider 1200 may determine a financial risk value associated with each identified target customer (Step 220). A customer's financial risk value may be associated with a customer's potential for making late payments and overcharging a financial account based on past payment history data. Also, a customer's financial risk value may be associated with the customer's income and debts. Financial account provider 1200 may consider several factors when determining a financial risk value for a customer. Such factors may be based on credit information received from one or more credit information sources (i.e., sources that provide credit information to financial account provider 1200). Credit information may also be provided to financial account provider 1200 when customers respond to the offers from provider 1200. Moreover, credit information may be requested by provider 1200 directly to a customer in previous solicitations. Credit information may include credit history information and/or personal information (e.g., income, employment status, etc.) that is used when evaluating a customer's credit worthiness. Credit information sources may comprise commercial credit information source (such as TRW/Experian, Equifax and TransUnion or a similar commercial credit service bureau) and/or private credit information services. Credit information sources may also represent credit information that was provided by customers, such as when a customer applied for an existing credit card.

In one configuration consistent with certain principles related to the present invention, financial account provider 1200 may generate an offer to a target customer based on the financial risk associated with that customer. For instance, an offer for a SGSG financial account may include indications of parameters associated with the product, such as an interest rate and credit limit. These parameters may vary based on the financial risk of the customer. Accordingly, a customer with a high financial risk may be offered a SGSG financial account with a credit limit of $300 while another customer with a lower financial risk may be offered a SGSG financial account with a credit limit of $1000. One skilled in the art would realize that a number of different parameters may be included and varied with each offer generated by financial account provider 1200 without departing from the scope of the present invention.

Once card issuer 1200 has identified a target group of customers and generated respective offers for each customer, the offers may be sent to response vehicle system 1100 for distribution to the customers (Step 230). Each response vehicle in vehicle 1100 processes the offers in order to provide them to the customers through communication channel 1400. For instance, response vehicle 1110 formulates offers for generation and viewing on one or more web sites. The web sites may be associated with a financial account provider's web site or sites. A customer may receive the offer when the web site is accessed through a computer system connected to communications channel 1400. Once each response vehicle has processed the offers, they are sent to the specified customers for response. Customers 1010-1040 may respond (accept or decline) to the offers using the medium associated with their category. The responses are sent back to response vehicle system 1100 (Step 240), where they are processed for presentation to card issuer 1200 (Step 250).

Based on the category of a customer, responses may or may not be processed immediately. For instance, responses may be received and processed instantaneously and/or automatically for customers 1010 and 1020, while responses from customers 1030 may be delayed. For example, suppose a customer 1010 using a personal computer views a web site operated by provider 1200. The web site may include a designated page that presents to the customer an offer generated by provider 1200. The customer may decide to accept or decline the offer by merely selecting an icon representing their choice and perhaps providing credit information through the web site. The response is then sent back to response vehicle 1110. Response vehicle 1110 processes the response and prepares it for presentation to card issuer 1200. The response is processed at card issuer 1200 and a notification may be sent back to customer 1010 through response vehicle 1110. The notification may indicate to the customer that their response to an offer has been processed and that they have been accepted or declined to receive a SGSG credit card product from financial account provider 1200. The notifications may be displayed through a web page that the customer was viewing when the offer was presented or displayed on a separate web page. Alternatively, financial account provider 1200 may provide an e-mail to the customer including the notification or a message indicating to the customer to check a particular web site to receive the notification.

As can be seen, a customer who has accepted an offer through a web site may receive immediate notification of an approval for financial account provided by provider 1200. On the other hand, a customer who has been solicited by conventional mail, such as customer 1030, may respond to the offer by mailing back an acceptance form to provider 1200. The acceptance form may be received and processed by response vehicle 1130, and eventually processed by financial account provider 1200. Notification of an acceptance (or decline) by financial account provider 1200 may then be sent back to the customer using the same conventional mail process.

There may be a plurality of variations available to provider 1200 when communicating with customers. That is, a mail customer 1030 may wish to respond by telephone or through a web site. Additionally, customers may respond by one medium, and request notification by another. For instance, a customer 1030 who has received an offer in the mail, may respond by mail, yet request notification by email. Accordingly, a variety of user friendly options are available to customers for receiving and responding to the offers presented by card issuer 1200. The above descriptions are for illustration purposes alone and should not be viewed as limitations to the present invention. One of ordinary skill in the art would realize that any number of combinations of communication techniques may be implemented without departing from the principles of the present invention.

In one configuration consistent with certain principles related to the present invention, the offers for a SGSG financial account may include indications of conditions and parameters associated with the plan that customers may be required to meet to maintain their membership. For example, an offer may indicate one or more parameters associated with the SGSG financial account, such as a credit limit and interest rate, and the criteria that may affect adjustments to those parameters. The criteria may include, for example, a predetermined number of consecutive timely payments that financial account provider 1200 must receive before issuer 1200 may increase a credit limit associated with the offered SGSG financial account. Alternatively, the criteria may also include a predetermined number of consecutive timely payments that financial account provider 1200 must receive before an interest rate associated with the offered SGSG financial account may be decreased.

Furthermore, the offer may also include indications of a floor and ceiling value reflecting the lowest and highest interest rate, respectively, for the SGSG financial account. Alternatively, the offer may include information associated with a Get Out Of Jail Free (GOOJF) offer. A GOOJF offer may be associated with past due payments that have not been received by provider 1200. The GOOJF offer may allow a customer to provide the past due payment within a specified period of time (e.g., 5 days), to avoid provider 1200 from adjusting terms of the SGSG financial account to terms less favorable to the customer. For example, the information included in the offer provided by credit issuer 1200 may indicate that failure of a customer to meet the criteria associated with the GOOJF offer (i.e., provide payment within the specified time period) may result in a higher interest rate. Alternatively, the offer may indicate that the past due payment may be categorized as a timely payment if the customer meets the criteria associated with the GOOJF offer (i.e., provide the past due payment within the specified period of time). One skilled in the art would realize that the information included in an offer for a SGSG product may include a number of various types of information, including different parameters and conditions associated with a SGSG financial account, and the present invention is not limited to the examples listed above.

Accordingly, notifications of the terms and conditions associated with a SGSG financial account may be provided to a customer through a SGSG offer. These notifications may allow the customer to be aware of the incentives and ramifications of potential payment activities associated with the SGSG account, should the customer accept the offer and provider 1200 activates a corresponding account. For example, a customer may receive a SGSG offer that includes an indication that the customer's SGSG account may receive an higher credit limit when a predetermined number of consecutive timely payments are made. Additionally, or alternatively, the offer may include an indication of a higher interest rate when a payment is missed or late. Accordingly, the customer is made aware of possible parameter adjustments that may be made by system 1000 and their corresponding criteria, prior to an adjustment actually taking place.

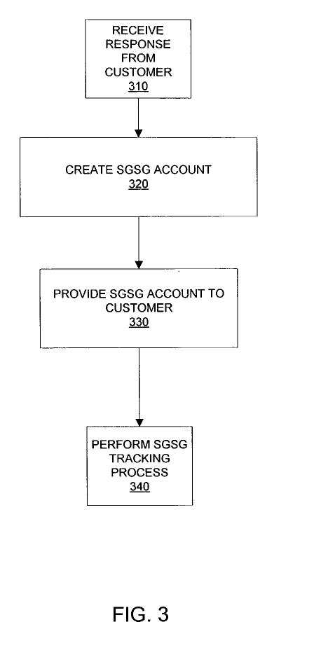

FIG. 3 illustrates an exemplary process that may be performed by financial account provider 1200 when processing a target customer's acceptance of the offers described with respect to FIG. 2. As shown, financial account provider 1200 may receive a response from a target customer indicating their acceptance of the offered SGSG financial account (Step 310). Once it receives their response, financial account provider 1200 may create a SGSG account associated with the customer in central database 1300 (Step 320). The SGSG account may include financial information, such as account numbers, customer identification information, parameters (i.e., credit limit, interest rate, penalty fee rates, etc.) and conditions (late payment time periods, GOOJF criteria, etc.) associated with the SGSG account. Once the SGSG account is created, financial account provider 1200 may provide the account to the customer (Step 330). For example, if the financial account is a credit card account, provider 1200 may provide a credit card product to the customer. Alternatively, if the financial account is a line of credit, provider 1200 may provide the customer with access to the line of credit (e.g., account information, identification codes, etc.). Afterwards, financial account provider 1200 may then monitor the SGSG account by performing a SGSG tracking process (Step 340).

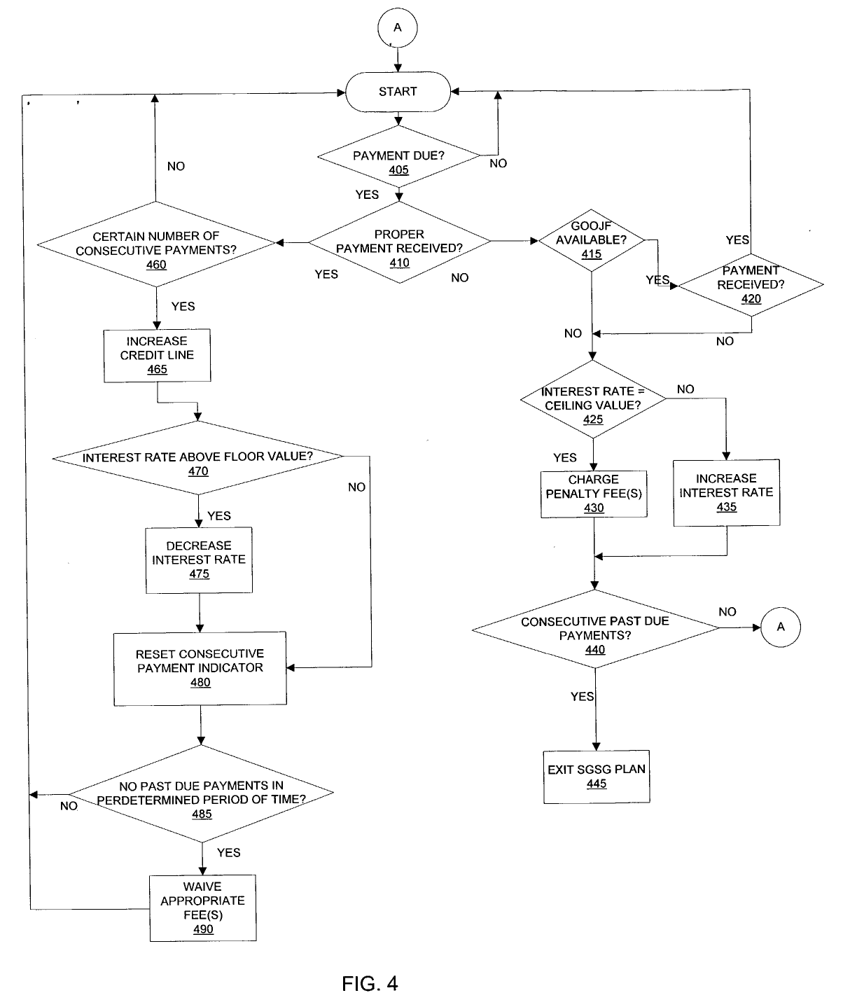

FIG. 4 shows a flowchart of an exemplary SGSG tracking process consistent with certain principles related to the present invention. The SGSG tracking process may be performed by financial account provider 1200 for each SGSG account stored in central database 1300. The tracking process may begin by financial account provider 1200 determining whether a payment associated with a customer's account is due (Step 405). In one configuration consistent with certain principles related to the present invention, system 1000 may allow account provider 1200 to access the customer's SGSG account to determine whether a payment is due based on due date information and credit balance information associated with the SGSG account. If system 1000 determines that no payment is due (Step 405; NO), the tracking process repeats itself until financial account provider determines that a payment is due. Once a payment is due (Step 405; YES), financial account provider 1200 determines whether a payment has been received (Step 410). System 1000 may also allow financial account provider 1200 to determine whether the payment meets certain criteria, such as whether the payment amount equals or exceeds the amount due. If the amount of the payment does not meet the criteria, or if no payment has been received (Step 410; NO), financial account provider 1200 may determine whether a GOOJF offer is available for the SGSG account (Step 415).

The GOOJF offer may be offered when the customer has a payment past due (i.e., financial account provider 1200 has not received a payment that is due by a predetermined due date). The GOOJF offer may allow the customer to provide the past due payment to financial account provider 1200 within a specified time period without receiving adjustments to their SGSG account that are less favorable to the customer (e.g., increase in an interest rate). Further, system 1000 may allow financial account provider 1200 to specify the conditions associated with a GOOJF offer. These conditions may include that the GOOJF offer is applied only to past due payments, past due fees, over limit fees, and interest rate adjustments. That is, financial account provider 1200 may waive any penalty fees associated with a past due payment when the customer meets the criteria for the GOOJF offer (i.e., provides the past due payment within the specified period of time). Also, the GOOJF conditions may include a condition that financial account provider 1200 readjusts an account term to a previous level more favorable to the customer (e.g., decrease an interest rate for the SGSG account if the interest rate was previously increased).

Additionally, in one configuration consistent with the present invention, the GOOJF conditions may include a condition that the GOOJF offer may be applied only once to a SGSG account and/or may be only used by the customer for the first past due payment. For example, even when a customer has never “redeemed” (used) the GOOJF offer, but has been past due on a payment more than one time, the customer may be excluded from using the GOOJF offer at a later time. One skilled in the art, however, would realize that financial account provider 1200 may define a condition that the GOOJF offer may be used more than once and/or at any time during the life of a SGSG account without departing from the scope of the invention. Furthermore, the GOOJF condition may include a condition that a GOOJF offer may be applied only if the customer is contacted via a telephone, perhaps through telephone response vehicle 1120, or any other medium specified by financial account provider 1200. Financial account provider 1200 may also define a GOOJF condition that allows the customer to contact financial account provider 1200 a certain time period after the customer's SGSG account went past due to benefit from the GOOJF offer. One skilled in the art would realize that financial account provider 1200 may implement a number of different GOOJF conditions without departing from the scope of the invention and the present invention is not limited to the examples described above.

Returning to FIG. 4, financial account provider 1200 determines whether a GOOJF offer is available based on the GOOJF conditions defined by issuer 1200 (Step 415). For example, financial account provider may determine whether the customer has previously used a GOOJF offer. If the GOOJF offer is available (Step 415; YES), financial account provider 1200 may attempt to contact the customer through a designated medium using response vehicle 1100. The customer may be presented with an offer to provide a past due payment within a specified time period. Financial account provider 1200 determines whether the past due payment has been received by the specified time period (Step 420), and if so (Step 420; YES), the SGSG tracking process may return to wait until financial account provider 1200 determines that another payment is due (Step 405). Alternatively, if financial account provider 1200 determines that the past due payment has not been received by the specified time period (Step 420; NO), system 1000 may then adjust an account parameter to a term less favorable to the customer.

For example, financial account provider 1200 may determine whether the customer's SGSG account has an interest rate equal to a ceiling value, such as 23.5%. To do so, financial account provider 1200 may access central database 1300 to analyze the parameter information associated with the SGSG account to determine the interest rate and a ceiling value associated with the account. If the current interest rate for the SGSG account is less than the ceiling value (Step 425; NO), financial account provider may increase the interest rate for the SGSG account by a certain amount (i.e., add 2% to the current interest rate) (Step 435). For example, suppose the ceiling value is set at 24%, the SGSG interest rate is currently at 23%, and the increment value by financial account provider 1200 may increase the SGSG interest rate is 2%. Therefore, a missed payment may result in financial account provider 1200 increasing the interest rate only to 24% instead of increasing the rate by 2% because of the ceiling value. Alternatively, if the interest rate of the SGSG account is equal to the ceiling value (Step 425; financial account provider 1200 may charge the customer one or more penalty fees based on the past due payment not being received (Step 430). One skilled in the art would realize that the amount the interest rate is adjusted may be predetermined by financial account provider 1200. This adjustment amount may be based on the financial account offered and activated by provider 1200 and included in the information provided with the offer to the customer, as described with reference to FIG. 2.

In one configuration consistent with certain principles related to the present invention, financial account provider 1200 may determine whether the missed payment was the third consecutive past due payment associated with the SGSG account (Step 440). If so, (Step 440; YES), financial account provider 1200 may terminate the SGSG account (Step 445). That is, the customer's SGSG account may be inactivated by financial account provider 1200 and the SGSG tracking process may end. On the other hand, in the event the missed payment was not the third consecutive past due payment missed, (Step 440; NO), the SGSG tracking process may return to Step 405 for processing a next payment for a following payment period (Step 405).

As described above, financial account provider 1200 may adjust account terms to values less favorable to the customer when financial account provider 1200 does not receive a proper payment due for a SGSG account. A proper payment may be associated with a timely payment, a payment that is equal to or larger than a minimum payment amount, or a combination of a timely payment equal to or larger than a minimum payment amount. On the other hand, when a proper payment is received (Step 410; YES), financial account provider 1200 may determine whether changes can be made to the SGSG account that are more favorable to the customer. In Step 460, financial account provider 1200 determines whether a certain number of consecutive timely payments (e.g., three consecutive payments) have been timely received, including the latest payment received. If not (Step 460; NO), the SGSG tracking process may return to Step 405 to wait for a next payment cycle. Alternatively, when financial account provider 1200 receives the certain number of consecutive timely payments (Step 460; YES), it may increase the credit limit associated with the SGSG account a certain amount based on the terms and conditions associated with the SGSG account. For example, financial account provider 1200 may increase the credit limit for a SGSG account by $100 for every three consecutive timely payments received.

In addition or alternative to increasing the credit limit for the SGSG account, financial account provider 1200 may adjust other parameters associated with the SGSG account. For example, in one aspect consistent with the present invention, financial account provider 1200 may determine whether the interest rate for the SGSG account is above a floor value (Step 470). If the interest rate is above the floor value (Step 470; YES) (which may reflect that the customer previously received an increase in their interest rate if the initial interest rate for the SGSG account was equal to the floor value), financial account provider 1200 may decrease the interest rate by a determined amount (i.e., subtract 2%) while ensuring that the interest rate does not fall below the floor value. (Step 475). Once the appropriate parameters for the SGSG account have been adjusted, financial account provider 1200 may reset an indicator associated with tracking consecutive received payments (Step 480). For example, financial account provider 1200 may reset a flag associated with the SGSG account in central database 1300 that reflects of the number of consecutive timely payments received by financial account provider 1200. One skilled in the art would realize that financial account provider 1200 may track the consecutive payments associated with a SGSG account using a number of different techniques without departing from the scope of the present invention. One skilled in the art would realize that the amount the credit limit is adjusted and the certain number of consecutive payments may be predetermined by financial account provider 1200. This adjustment amount and consecutive payment number may be based on the financial account offered and activated by provider 1200 and included in the information provided with the offer to the customer, as described with reference to FIG. 2.

In addition to the adjustments of interest rates and credit limits, financial account provider 1200 may also provide additional rewards to a SGSG customer who consistently provides timely consecutive payments to financial account provider 1200. In one configuration consistent with certain principles related to the present invention, financial account provider 1200 may determine whether it has received a second predetermined number of consecutive timely payments, such as twelve (Step 485). If not, the SGSG tracking process returns to the beginning of the process to wait for a next determined payment that is due (Step 405). If, on the other hand, financial account provider 1200 has received a second predetermined number of consecutive timely payments, financial account provider 1200 may waive certain fees associated with the SGSG account, such as an annual membership fee. One skilled in the art would realize that financial account provider 1200 may offer other incentives to the SGSG customer for providing a second number of consecutive timely payments, such as a decrease in the floor value of the SGSG account's interest rate and providing an additional increase to the SGSG account's credit limit (which may be larger than the incremented credit limit increases provided by financial account provider 1200 when it receives the first predetermined number of consecutive timely payments).

As described, methods, systems, and articles of manufacture consistent with certain principles related to the present invention enable financial account provider 1200 to adjust one or more parameters associated with a SGSG account based on monitored payment activities associated with the account. Additionally, financial account provider 1200 may provide messages to a SGSG customer reflecting the status of their SGSG account based on the monitored payment activities. These messages may be provided with a billing statement generated by financial account provider 1200 and provided to the SGSG customer. Alternatively, the messages may be included in a separate communication sent to the SGSG customer.

Table I shows a listing of exemplary messages that may be provided by financial account provider 1200 based on the monitored payment activities. One skilled in the art would realize that the messages included in Table I are not intended to be limiting and that methods, systems, and articles of manufacture consistent with certain features of the present invention may implement various other types of messages with various information included therein, without departing from the scope of the present invention.

TABLE I
Exemplary Messages
Credit Line Increase Messages

A. You will receive a $<dollar amount value> credit limit increase after only <X> more
consecutive on-time payments.
B. Congratulations! Your <first predetermined number (i.e., 3)> consecutive on-time payments
have earned you a $<dollar amount value> credit line increase. Your new credit limit is
$<previous credit limit + dollar amount value>.

Get Out of Jail Free Message

C. Your scheduled payment was not received at the time your statement was processed. If you
do not contact us immediately, your APR will increase <percentage amount>% to <adjusted
APR>%. Please call <phone number> and we can help you make arrangements for this payment.

Repricing Messages

D. You account is past due. Please note that unless your scheduled payment arrived by <cycle
date + 5> your APR will increase by <percentage amount>% to <adjusted APR>%. This change
will be reflected on your next statement.
E. Your APR has increased by <APR percentage amount>% to <adjusted APR>%. But if you
make <X> more consecutive on-time payments, we'll lower your APR by <percentage
amount>%.

Unrepricing Messages

F. You will receive a <percentage amount>% decrease after only <X> more consecutive on-time
payment(s)!
G. Congratulations! Your <first predetermined number (i.e., 3)> consecutive on-time payments
have earned you a <percentage amount>% decrease to your previous rate of <adjusted APR>%.
This change will be reflected on your next statement.

Additional Benefit Message

H. Congratulations! In recognition of your excellent payment history that included <second
predetermined number (i.e., 12)> consecutive on-time payments, we are waiving this year's
Annual Membership Fee!

The exemplary messages included in Table 1 may be provided to the SGSG customer based on certain events detected by financial account provider 1200 during the SGSG tracking process. For example, suppose the following series of events (e.g., payment activities) are associated with a SGSG customer's account:

Statement 1 phase: Financial account provider 1200 provides an SGSG customer with an SGSG financial account and statement.

Statement 2 phase: Financial account provider 1200 receives an on time first payment equal to a minimum payment.

Statement 3 phase: Financial account provider 1200 does not receive a second payment for the SGSG account by a payment due date.

Financial account provider 1200 may then provide the following messages to the SGSG customer subsequent to the payment activity of each statement phase:

Statement 1 phase: Provide Credit Line Increase Message A to SGSG customer.

Statement 2 phase: Provide Credit Line Increase Message A to SGSG customer, where X=X−1.

Statement 3 phase: Provide either Get Out of Jail Free Message C or Repricing message D to SGSG customer.

As described, methods, systems, and articles of manufacture consistent with certain principles related to the present invention enable a financial account provider to adjust selected parameters associated with a customer's financial account based on the payment activities associated with the account. For example, the financial account provider may reduce or increase an interest rate associated with the customer's account based on payments received (or not received) for the account. Alternatively, the financial account provider may increase a credit limit associated with the financial account and/or reduce fees that are charged to the account based on received payments for the account.

Although the present invention has been described based on the system environment 1000 shown in FIG. 1, one skilled in the art would realize that various other configurations may be employed by methods, systems, and articles of manufacture consistent with certain principles related to the present invention without affecting its scope.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. For example, the process steps shown in FIGS. 2-4 are not limited to the sequences described above. Variations of these sequences, such as the removal and/or the addition of other processes may be implemented without departing from the spirit and scope of the present invention. For example, in one aspect of the present invention, the SGSG plan may be modified to allow a customer to receive benefits associated with making proper payments without the customer's account ever being adjusted in a manner less favorable to the customer. In this respect, provider 1200 may still adjust an account parameter to a value more favorable to the customer when the customer makes proper payments to provider 1200, but may make no adjustments when the customer does not make any proper payments (e.g., a missed or late payment). For example, provider 1200 may reduce the APR of a customer's account by 0.25% for every on-time payment received from the customer until the APR reaches a predetermined floor value. Continuing with this example, provider 1200 may not decrease the customer's APR when the customer makes a late payment. Provider 1200, however, may resume making adjustments to one or more parameters of the customer's account following a proper payment received from the customer. Accordingly, a customer may obtain increased financial benefits from provider 1200 based on proper payment activities associated with a financial account, yet at the same time not receive reductions in financial benefits (i.e., an account parameter being adjusted to a less favorable value, such as a higher APR, lower credit limit, etc.) if they fail to provide a proper payment to provider 1200.

Additionally, the processes described with reference to financial account provider 1200 may be performed by hardware and/or software with or without the aid of user intervention. For example, processors and corresponding software may automatically determine target customers and the types of SGSG offers to be presented to these target customers. Further, the processors and software executing in provider 1200 may also perform the monitoring process described with respect to FIG. 4. Alternatively, a combination of user input/output and hardware/software operations may be implemented to perform certain features related to the present invention. Accordingly, one skilled in the art would realize that the present invention is not limited to autonomous or complete user-controlled operation and any combination of these may be implemented without departing from the scope of the invention.

Furthermore, the financial account provider 1200 may adjust a customer's financial risk value based the customer's progress in satisfying the payment criteria associated with a SGSG financial account. For example, a customer may be provided a SGSG financial account with parameters that are defined based on the credit risk of the customer (e.g. an initial interest rate of 20% and credit limit of $500). After a predetermined amount of time, financial account provider 1200 may re-evaluate the customer's credit risk and make adjustments to the account parameters based on a monitored progress of the customer satisfying criteria associated with the financial account (e.g., making consecutive timely proper payments). These adjustments may be in addition to adjustments previously made to the account's parameters based on proper payments. For example, suppose the customer made proper payments to the account for 12 consecutive months. During these 12 months, the interest rate for the account may have been reduced to 14% and the credit limit increased to $1,000 based on the consecutive timely payments made by the customer. Based on the customer's progress during the previous 12 months, financial account provider 1200 may determine that the customer is less of a financial risk compared to when the customer initially obtained the financial account.

Accordingly, the account provider 1200 may provide the customer additional account parameter adjustments based on the customer's updated credit risk. For example, the account provider may reduce a floor interest rate value that enables the customer to obtain an even lower interest rate based on continued good performance (i.e., continue to make timely consecutive proper payments, not exceeding a credit limit, etc.). Alternatively, the account provider 1200 may reduce the interest rate based on the updated credit risk (e.g., 14% to 13.8%) or increase the credit limit (e.g., increase credit limit by $500). One of ordinary skill in the art would realize that different types of adjustments may be made to the customer's account without departing from the scope of the invention. For instance, adjustments to the financial account may be less favorable to the customer based on the customer's updated credit risk value. For example, financial account provider 1200 may determine that a customer who has missed payment during a monitored 12 month period may be determined to be a higher credit risk compared to when the customer initially received the financial account. Based on the customer's new determined credit risk, account provider 1200 may increase the interest rate and/or decrease the credit limit associated with the financial account. Alternatively, the customer's account may be closed.

Additionally, the present invention may be applied to a number of different types of financial accounts, such as credit card accounts, lines of credits, financial loans, etc. Further, any type of financial institution that provides financial accounts to customers may employ methods, systems, and articles of manufacture consistent with certain principles related to the present invention. For example, a bank which provides financial loans to customers may implement certain features related to the present invention to provide a customer with a SGSG financial account. Also, the bank may monitor the progress of the customer's account in accordance with certain principles related to the present invention.

Furthermore, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents

What is claimed is:

1. A method for managing a customer's financial account having an account parameter, comprising:
providing payment criteria to the customer, wherein the payment criteria indicates that the account parameter may be adjusted based on whether the payment criteria is satisfied;
determining whether the payment criteria is satisfied based on payments made to the account; and
adjusting the account parameter based on the determination.

2. The method of claim 1, wherein determining whether the payment criteria is satisfied comprises:
notifying the customer that the account parameter will be adjusted based on whether a predetermined number of proper payments to the financial account are received.

3. The method of claim 1, wherein adjusting the account parameter comprises:
adjusting a fee charged to the financial account based on whether a payment was received.

4. The method of claim 3, wherein the fee is based on an interest rate applied to a debt associated with the financial account.

5. The method of claim 3, wherein the fee is a fixed fee amount periodically charged to the customer.

6. The method of claim 3, wherein the fee is adjusted by an amount previously indicated to the customer.

7. The method of claim 3, wherein adjusting a fee includes at least one of increasing the fee when payment was not received and decreasing the fee when the payment was received.

8. The method of claim 1, wherein the account parameter is a credit limit and adjusting the account parameter comprises:
adjusting the credit limit for the financial account based on whether a payment was received.

9. The method of claim 8, wherein the credit limit is adjusted by an amount previously indicated to the customer.

10. The method of claim 4, wherein adjusting the fee comprises one of:
decreasing the interest rate by a predetermined amount, such that the interest rate is not below a floor interest rate value; and
increasing the interest rate by a predetermined amount such that the interest rate is not above a ceiling interest rate value.

11. The method of claim 3, wherein adjusting the fee further comprises:
reducing the fee charged to the financial account based on a determination that a predetermined number of consecutive payments have been received.

12. The method of claim 1, wherein determining whether the payment criteria is satisfied further comprises:
when the payment criteria was not satisfied, adjusting the payment criteria to allow the customer to provide a past due payment within a predetermined period of time; and
adjusting the account parameter based on a determination that the adjusted payment criteria was satisfied.

13. The method of claim 1, further comprising:
tracking a progress of the customer towards satisfying the payment criteria; and
providing an indication of the tracked progress to the customer.

14. The method of claim 13, wherein the indication includes a notification of when the account parameter will be adjusted based on the tracked progress.

15. The method of claim 13, wherein the indication includes a notification of how the account parameter will be adjusted based on the tracked progress.

16. The method of claim 1, wherein adjusting the account parameter comprises:
adjusting the account parameter in a manner less favorable to the customer based on a determination that the customer did not make a payment to the financial account.

17. A method for managing a customer's financial account having an account parameter, comprising:
providing payment criteria to the customer, wherein the payment criteria indicates that the account parameter may be adjusted based on whether the payment criteria is satisfied;
determining whether the payment criteria is satisfied based on payments made to the account; and
adjusting the account parameter in a manner more favorable to the customer when the customer satisfies the payment criteria, and keeping the account parameter constant when the customer does not satisfy the payment criteria.

18. A computer-readable medium including instructions for performing, when executed by a processor, a method for managing a customer's financial account having an account parameter, the method comprising:
providing payment criteria to the customer, wherein the payment criteria indicates that the account parameter may be adjusted based on whether the payment criteria is satisfied;
determining whether the payment criteria is satisfied based on payments made to the account; and
adjusting the account parameter based on the determination.

19. The computer-readable medium of claim 18, wherein determining whether the payment criteria is satisfied comprises:
notifying the customer that the account parameter will be adjusted based on whether a predetermined number of proper payments to the financial account are received.

20. The computer-readable medium of claim 18, wherein adjusting the account parameter comprises:
adjusting a fee charged to the financial account based on whether a payment was received.

21. The computer-readable medium of claim 20, wherein the fee is based on an interest rate applied to a debt associated with the financial account.

22. The computer-readable medium of claim 20, wherein the fee is a fixed fee amount periodically charged to the customer.

23. The computer-readable medium of claim 20, wherein the fee is adjusted by an amount previously indicated to the customer.

24. The computer-readable medium of claim 20, wherein adjusting a fee includes at least one of increasing the fee when payment was not received and decreasing the fee when the payment was received.

25. The computer-readable medium of claim 18, wherein the account parameter is a credit limit and adjusting the account parameter comprises:
adjusting the credit limit for the financial account based on whether a payment was received.

26. The computer-readable medium of claim 25, wherein the credit limit is adjusted by an amount previously indicated to the customer.

27. The computer-readable medium of claim 21, wherein adjusting the fee comprises one of:
decreasing the interest rate by a predetermined amount, such that the interest rate is not below a floor interest rate value; and
increasing the interest rate by a predetermined amount such that the interest rate is not above a ceiling interest rate value.

28. The computer-readable medium of claim 20, wherein adjusting the fee further comprises:
reducing the fee charged to the financial account based on a determination that a predetermined number of consecutive payments have been received.

29. The computer-readable medium of claim 18, wherein determining whether the payment criteria is satisfied further comprises:
when the payment criteria was not satisfied, adjusting the payment criteria to allow the customer to provide a past due payment within a predetermined period of time; and
adjusting the account parameter based on a determination that the adjusted payment criteria was satisfied.

30. The computer-readable medium of claim 18, further comprising:
tracking a progress of the customer towards satisfying the payment criteria; and
providing an indication of the tracked progress to the customer.

31. The computer-readable medium of claim 30, wherein the indication includes a notification of when the account parameter will be adjusted based on the tracked progress.

32. The computer-readable medium of claim 30, wherein the indication includes a notification of how the account parameter will be adjusted based on the tracked progress.

33. The computer-readable medium of claim 18, wherein adjusting the account parameter comprises:
adjusting the account parameter in a manner less favorable to the customer based on a determination that the customer did not make a payment to the financial account.

34. A computer-readable medium including instructions for performing, when executed by a processor, a method for managing a customer's financial account having an account parameter, the method comprising:
providing payment criteria to the customer, wherein the payment criteria indicates that the account parameter may be adjusted based on whether the payment criteria is satisfied;
determining whether the payment criteria is satisfied based on payments made to the account; and
adjusting the account parameter in a manner more favorable to the customer when the customer satisfies the payment criteria, and keeping the account parameter constant when the customer does not satisfy the payment criteria.

35. A system for managing a customer's financial account having an account parameter, comprising:
means for providing payment criteria to the customer, wherein the payment criteria indicates that the account parameter may be adjusted based on whether the payment criteria is satisfied;
means for determining whether the payment criteria is satisfied based on payments made to the account; and
means for adjusting the account parameter based on the determination.

36. The system of claim 35, wherein determining whether the payment criteria is satisfied comprises:
means for notifying the customer that the account parameter will be adjusted based on whether a predetermined number of proper payments to the financial account are received.

37. The system of claim 35, wherein adjusting the account parameter comprises:
means for adjusting a fee charged to the financial account based on whether a payment was received.

38. The system of claim 37, wherein the fee is based on an interest rate applied to a debt associated with the financial account.

39. The means for of claim 37, wherein the fee is a fixed fee amount periodically charged to the customer.

40. The means for of claim 37, wherein the fee is adjusted by an amount previously indicated to the customer.

41. The system of claim 37, wherein the means for adjusting a fee includes means for increasing the fee when payment was not received and decreasing the fee when the payment was received.

42. The system of claim 35, wherein the account parameter is a credit limit and the means for adjusting the account parameter comprises:
means for adjusting the credit limit for the financial account based on whether a payment was received.

43. The system of claim 42, wherein the credit limit is adjusted by an amount previously indicated to the customer.

44. The system of claim 38, wherein the means for adjusting the fee comprises one of:
means for decreasing the interest rate by a predetermined amount, such that the interest rate is not below a floor interest rate value; and
means for increasing the interest rate by a predetermined amount such that the interest rate is not above a ceiling interest rate value.

45. The system of claim 35, wherein the means for adjusting the fee further comprises:
means for reducing the fee charged to the financial account based on a determination that a predetermined number of consecutive payments have been received.

46. The system of claim 35, wherein the means for determining whether the payment criteria is satisfied further comprises:
means for, when the payment criteria was not satisfied, adjusting the payment criteria to allow the customer to provide a past due payment within a predetermined period of time; and
means for adjusting the account parameter based on a determination that the adjusted payment criteria was satisfied.

47. The system of claim 35, further comprising:
means for tracking a progress of the customer towards satisfying the payment criteria; and
means for providing an indication of the tracked progress to the customer.

48. The system of claim 46, wherein the indication includes a notification of when the account parameter will be adjusted based on the tracked progress.

49. The system of claim 46, wherein the indication includes a notification of how the account parameter will be adjusted based on the tracked progress.

50. The system of claim 35, wherein adjusting the account parameter comprises:
adjusting the account parameter in a manner less favorable to the customer based on a determination that the customer did not make a payment to the financial account.

51. A system for managing a customer's financial account having an account parameter, comprising:
means for providing payment criteria to the customer, wherein the payment criteria indicates that the account parameter may be adjusted based on whether the payment criteria is satisfied;
means for determining whether the payment criteria is satisfied based on payments made to the account; and
means for adjusting the account parameter in a manner more favorable to the customer when the customer satisfies the payment criteria, and keeping the account parameter constant when the customer does not satisfy the payment criteria.
